(19) United States
(12) Patent Application Publication
(10) Pub. No.: US 2020/0130663 A1
(43) Pub. Date: Apr. 30, 2020

(54) BRAKE PEDAL FEEL ADJUSTMENT DUE TO VEHICLE MODE OR DRIVER BIOMETRICS

(71) Applicant: Continental Automotive Systems, Inc., Auburn Hills, MI (US)

(72) Inventors: Bo Ye, Rochester Hills, MI (US); Pedro Henriques, Rochester Hills, MI (US)

(73) Assignee: Continental Automotive Systems, Inc., Auburn Hills, MI (US)

(21) Appl. No.: 16/174,675

(22) Filed: Oct. 30, 2018

(51) Int. Cl. B60T 8/40

(52) U.S. Cl. CPC B60T 8/409; B60T 2220/02; B60T 2220/04; B60T 2270/82

(57) ABSTRACT

A method adjusts a brake pedal feedback in a brake-by-wire vehicle brake system. The brake system includes a brake pedal and a simulation device associated with the brake pedal such that in a brake-by-wire mode of operation, the simulation device provides brake pedal feedback to the driver. An input signal is provided to a processor circuit of a control unit of the brake system. The input signal relates to a desired brake pedal feedback associated with a driver of the vehicle. The processor circuit generates a brake pedal feel output signal based on data regarding vehicle deceleration vs. travel of the brake pedal and on data regarding the vehicle deceleration vs. force on the brake pedal. Based on the brake pedal feel output signal, the control unit controls an output of the simulation device to establish the desired brake pedal feedback.

### FIELD

This invention relates braking of a vehicle and, more particularly, to a brake-by-wire vehicle brake system that adjusts the brake pedal feedback depending on vehicle mode selection, driver biometrics, or Man-Machine Interface (MMI) available to the driver.

### BACKGROUND

With conventional brake-by-wire braking systems, during a normal braking function, the master brake cylinder and therefore the vehicle driver is disconnected from the wheel brakes and a simulator is activated so that a pressure medium volume, which is expelled in the master bake cylinder as a result of activation of the brake pedal by the driver, is taken up by the simulator. The simulator communicates a predetermined brake pedal sensation to the vehicle driver. However, such brake pedal sensation is not adjustable for the feedback desired by the current vehicle driver.

Thus, there is a need to provide a vehicle braking system that adjusts the brake pedal feedback depending on vehicle mode selection, driver biometrics or Man-Machine Interface (MMI) available to the driver.

### SUMMARY

An object of an embodiment is to fulfill the need referred to above. In accordance with the principles of an embodiment, this objective is obtained by providing a brake-by-wire vehicle brake system which is configured to operate in a hydraulic mode of operation and in a brake-by-wire mode of operation. The brake system includes a brake pedal. As pressure medium reservoir container is constructed and arranged contain a pressure medium therein. A hydraulic activation unit is constructed and arranged to be activated by the brake pedal in the hydraulic mode of operation to control delivery of the pressure medium to wheel brakes of a vehicle. A simulation device is constructed and arranged to interact with the hydraulic activation unit such that in the brake-by-wire mode of operation, the brake pedal is disconnected from the hydraulic activation unit, with the simulation device providing brake pedal feedback to the driver. An electrically controllable pressure supply device is constructed and arranged to deliver the pressure medium to the wheel brakes during the brake-by-wire mode of operation. A control unit is constructed and arranged to establish, at the simulation device, a desired brake pedal feedback based on driver input.

In accordance with another aspect of an embodiment, a method is provided for adjusting a brake pedal feedback in a brake-by-wire vehicle brake system which is configured to operate in a hydraulic mode of operation and in a brake-by-wire mode of operation. The brake system includes a brake pedal and a simulation device associated with the brake pedal such that in a brake-by-wire mode of operation, the simulation device provides brake pedal feedback to the driver. An input signal is provided to a processor circuit of a control unit of the brake system. The input signal relates to a desired brake pedal feedback associated with a driver of the vehicle. The processor circuit generates a brake pedal feel output signal based on data regarding vehicle deceleration vs. travel of the brake pedal and on data regarding the vehicle deceleration vs. force on the brake pedal. Based on the brake pedal feel output signal, the control unit controls an output of the simulation device to establish the desired brake pedal feedback.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a hydraulic circuit diagram of an exemplary vehicle brake system in accordance with an embodiment of the invention.

FIG. 2 is a graph of vehicle deceleration versus brake pedal rod travel during braking of the system of FIG. 1.

FIG. 3 is a graph of vehicle deceleration versus brake pedal force during braking of the system of FIG. 1.

FIG. 4 is a schematic view of a processor circuit of the ECU of the system of FIG. 1 receiving a driver request signal and outputting a pedal feel output signal based on the request signal.

FIG. 5 is a flow chart of a method of the embodiment.

### DETAILED DESCRIPTION OF THE EXEMPLARY EMBODIMENTS

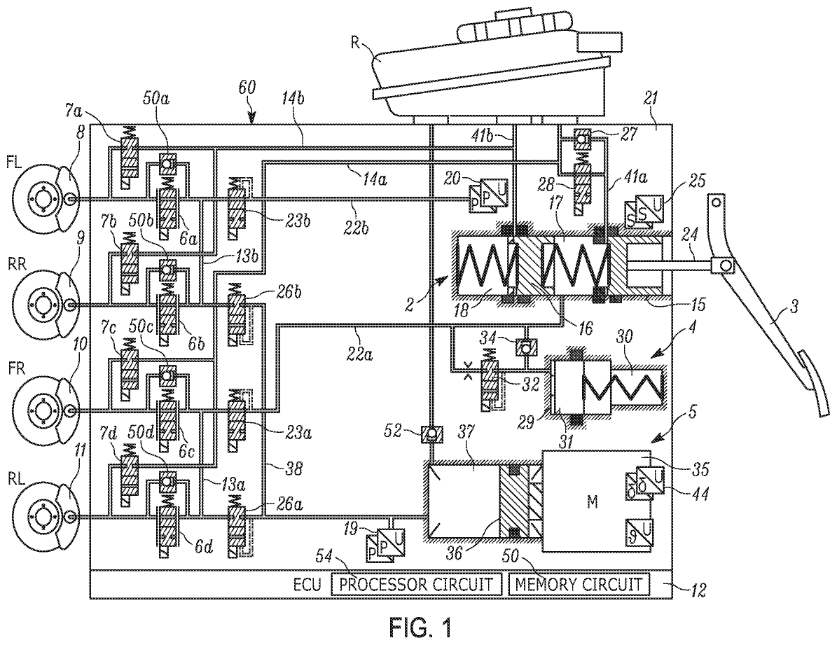

A brake-by-wire vehicle brake system, generally indicated at 1 in FIG. 1, includes a hydraulic activation unit 2 which can be activated by means of a brake pedal 3, a travel simulator or simulation device 4 which interacts with the hydraulic activation unit 2, a pressure medium reservoir container R which is assigned to the hydraulic activation unit 2 and is at atmospheric pressure, an electrically controllable pressure supply device 5, an electronic open-loop and closed-loop control unit (ECU) 12 and an electrically controllable pressure modulation device for setting wheel-specific brake pressures. The brake system 1 can be of the type disclosed in U.S. Pat. No. 9,415,758 B2, the contents of which is hereby incorporated by reference into this Specification.

The brake modulation device (not denoted here in more detail) comprises, for example, per wheel brake 8, 9, 10, 11 of a motor vehicle (not shown), an inlet valve 6a-6d and an outlet valve 7a-7d, which are hydraulically connected in pairs to one another via center ports and to the wheel brakes 8, 9, 10, 11. The inlet ports of the inlet valves 6a-6d are supplied, by means of brake circuit supply lines 13a, 13b, with pressures which in a “brake-by-wire” operating mode are derived from a system pressure which is present in a system pressure line 38 which is connected to a pressure space 37 of the electrically controllable pressure supply device 5. Connected in parallel with each of the inlet valves 6a-6d is a non-return valve 50a-50d which opens toward the brake circuit supply lines 13a, 13b. In a non-boosted fallback operating mode, the brake circuit supply lines 13a, 13b are supplied with the pressures of the pressure spaces 17, 18 of the activation unit 2 via hydraulic lines 22a, 22b. The outlet ports of the outlet valves 7a-7d are connected in pairs to the pressure medium reservoir container R via return flow lines 14a, 14b. In order to detect the pressure present in the system pressure line 38, a pressure sensor 19 which is of preferably redundant design is provided.

The hydraulic activation unit 2 has, in a housing 21, two pistons 15, 16 which are arranged one behind the other and which bound hydraulic chambers or pressure spaces 17, 18 which form, together with the pistons 15, 16, a dual-circuit master brake cylinder or a tandem master cylinder. The pressure spaces 17, 18 are connected, on the one hand, to the pressure medium reservoir container R, via radial bores formed in the pistons 15, 16 and corresponding pressure equalization lines 41a, 41b (via the return flow line 14a and 14b) wherein the bores and lines 41a, 41b can be shut off by a relative movement of the pistons 17, 18 in the housing 21 and, on the other hand, to brake circuit supply lines 13a, 13b by means of the hydraulic lines 22a, 22b. In this context, a parallel connection of a diagnostic valve 28 which is open in the currentless state, with a non-return valve 27 which closes toward the pressure medium reservoir container R, is contained in the pressure equalization line 41a. The pressure spaces 17, 18 accommodate resetting springs (not denoted in more detail) which position the pistons 15, 16 in an initial position when the master brake cylinder or activation unit 2 is not activated. A piston rod 24 couples the pivoting movement of the brake pedal 3 owing to a pedal activation to the translatory movement of the first (master cylinder) piston 15 whose activation travel is detected by a travel sensor 25, preferably of redundant design. The corresponding piston travel signal is as a result a measure of the brake pedal activation angle. It represents a braking request of a vehicle driver.

The simulation device 4 can be hydraulically coupled to the master brake cylinder 2 and is composed essentially of a simulator chamber 29, a simulator spring chamber 30 and a simulator piston 31 which disconnects the two chambers 29, 30 from one another. The simulator piston 31 is supported on the housing 21 by an elastic element (for example a spring or elastomer member) which is arranged in the simulator spring chamber 30 and is advantageously prestressed. The simulator chamber 29 can be connected to the first pressure space 17 of the tandem master brake cylinder 2 by means of an electrically activated simulator release valve 32. When a desired pedal force is determined (as explained below) and the simulator release valve 32 is activated, pressure medium flows from the master brake cylinder pressure space 17 into the simulator chamber 29. A non-return valve 34 which is arranged hydraulically in an anti-parallel fashion with respect to the simulator release valve 32 permits, independently of the switched state of the simulator release valve 32, approximately unimpeded flowing back of the pressure medium from the simulator chamber 29 to the master brake cylinder pressure space 17.

The electrically controllable pressure supply device 5 is embodied as a hydraulic cylinder-piston arrangement or a single-circuit electrohydraulic actuator whose piston 36 can be activated by a schematically indicated electric motor 35 with intermediate connection of a rotational translatory gear mechanism (also illustrated schematically). A rotor position sensor which serves to detect the rotor position of the electric motor 35 and is indicated in a merely schematic fashion is denoted by the reference symbol 44. In addition, a temperature sensor can also be used to sense the temperature of the motor winding. The piston 36 bounds a pressure space 37.

The actuator pressure which is generated by the force effect of the piston 36 on the pressure medium which is enclosed in the pressure space 37 is fed into the system pressure line 38 and detected by the system pressure sensor 19. In the “brake-by-wire” operating mode, the system pressure line 38 is connected to the brake circuit supply lines 13a, 13b via the sequence valves 26a, 26b. In this way, in the case of normal braking, wheel brake pressure is built up and reduced for all the wheel brakes 8, 9, 10, 11. When pressure is reduced, the pressure medium which has been previously moved into the wheel brakes 8, 9, 10, 11 from the pressure space 37 of the actuator 6 flows back again into the pressure space 37 of the actuator 5 in the same way. In contrast, in the case of braking with wheel brake pressures which are regulated differently on a wheel-specific basis using the modulation valves 6a-6d, 7a-7d, the pressure medium portion which is discharged via the outlet valves 7a-7d flows into the pressure medium reservoir container R. Subsequent sucking of pressure medium into the pressure space 37 is possible as a result of the piston 36 moving back with the sequence valves 26a, 26b closed, by virtue of the fact that pressure medium can flow out of the container R into the actuator pressure space 37 via a suction valve 52 which is embodied as a non-return valve which is open in the direction of flow to the actuator.

The components 2, 3, 5, 6a-6d, 7a-7d, 12, 19, 20, 22a, 22b, 23a, 23b, 25, 26a, 26b, 27, 28, 32, 34, 38, 41a, 41b, 44, 46, 52 mentioned above are preferably combined to form an electro-hydraulic module (electrohydraulic activation unit) which is provided with the reference symbol 60. The electronic open-loop and closed-loop control unit 12 is used for actuating the electrically activated components of the module 60, in particular the valves 6a-6d, 7a-7d, 23a, 23b, 26a, 26b, 28, 32 and of the electric motor 35 of the pressure supply device 5. The signals of the sensors 19, 20, 25 and 44 are also processed in the electronic open-loop and closed-loop control unit 12.

In a normal braking function of the brake system (“brake-by-wire” operating mode), the master brake cylinder 2, and therefore the vehicle driver, is disconnected from the wheel brakes 8, 9, 10, 11 by the closed isolating valves 23a, 23b, and the brake circuit supply lines 13a, 13b are connected via the opened sequence valves 26a, 26b to the first pressure supply device 5 which makes available the system pressure for the activation of the wheel brakes 8, 9, 10, 11. The simulation device 4 is activated by the opened simulator release valve 32, so that the pressure medium volume which is expelled in the master brake cylinder 2 as a result of the activation of the brake pedal 3 by the driver is taken up by the simulation device 4, and the simulation device 4 communicates a brake pedal feedback to the vehicle driver.

In a fallback, hydraulic operating mode of the brake system 1, for example in the event of a failure of the electrical energy supply of the brake system, the simulation device 4 is switched off by the simulator release valve 32 which is closed in a currentless state, and the pressure supply device 5 is disconnected from the brake circuit supply lines 13a, 13b by the sequence valves 26a, 26b which are closed in the currentless state. The master brake cylinder 2 is connected via the lines 22a, 22b to the isolating to valves 23a, 23b, open in the currentless state, by the brake circuit supply lines 13a, 13b, and therefore to the wheel brakes 8, 9, 10, 11, so that the vehicle driver can build up pressure directly in the wheel brakes 8, 9, 10, 11 by activating the brake pedal 3.

In a simulator brake mode (in the “brake-by-wire” operating mode), the pedal 3 is hydraulically disconnected from the wheel brakes 8-11. The pedal reactions which are unavoidable in conventional brake systems during wheel brake pressure regulating activities of the brake system therefore do not occur. In accordance with the embodiment, the system 1 provides the driver with different pedal feedback options to provide optimum feedback to the driver for improved driver satisfaction.

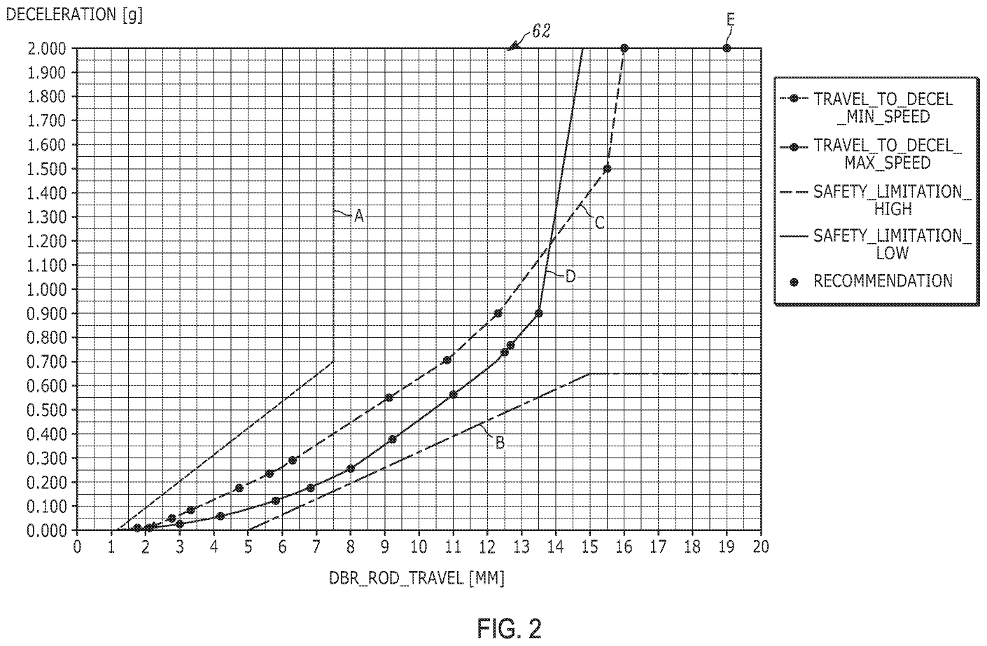

FIG. 2. is a graph of vehicle deceleration versus travel of the brake pedal rod 24 during the “brake-by-wire” operating mode of the system of FIG. 1. Curves A and B represent the high and low safety limitations, curve C represents travel to deceleration max speed, curve D represents travel to deceleration at minimum speed and point E represents a recommended pedal rod travel at a certain deceleration.

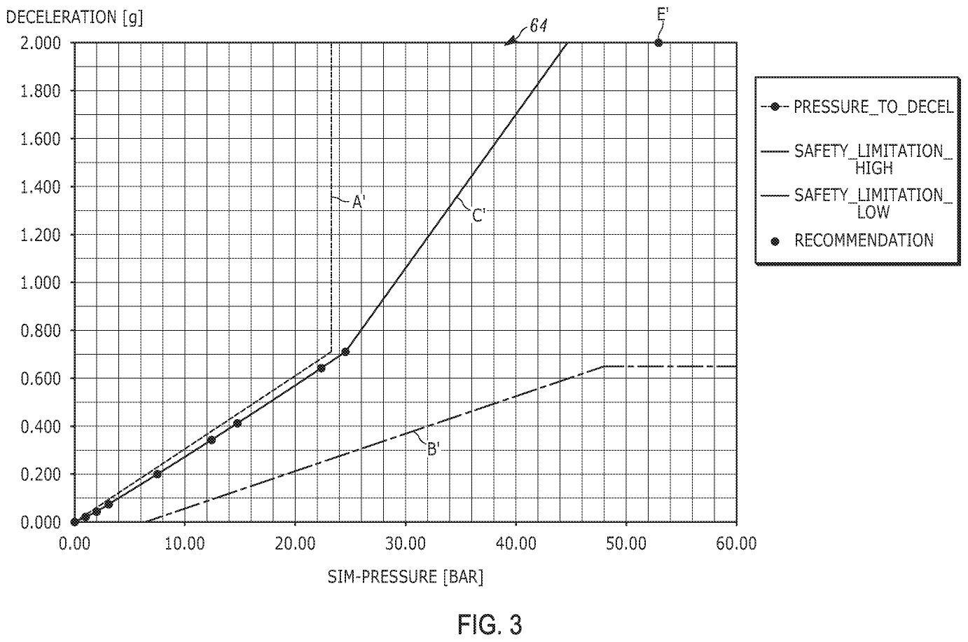

FIG. 3 is a graph of vehicle deceleration versus brake pedal force during the “brake-by-wire” operating mode of the system of FIG. 1. Curves A′ and B′ represent the high and low safety limitations, curve C′ represents the pressure to deceleration and point E′ represents a recommended brake pedal pressure travel at a certain deceleration.

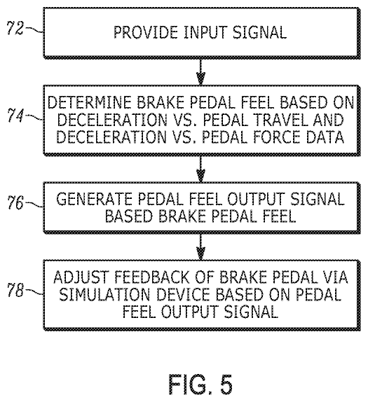

The data from the graphs in FIGS. 2 and 3 is stored in a memory circuit 50 of the ECU 12 (FIG. 1). With reference to FIG. 5, a processor circuit 54 is constructed and arranged to determine, based on an input signal 56 relating to the driver, a pedal output feel signal 58 that is customized for the particular driver. Output signal 58 is determined based on a combination of the data 62, 64 of the graphs stored in memory circuit 50 and processed by the processor circuit 54. Output signal 58 is then provided to the brake control unit (e.g., ECU 12). The brake control unit 12 then uses a preset calibration setup according to the selected brake feedback option to adjust the brake pedal feedback so as to provide the selected feel or feedback of pedal 3 to the driver by controlling the pressure output to the simulation device 4.

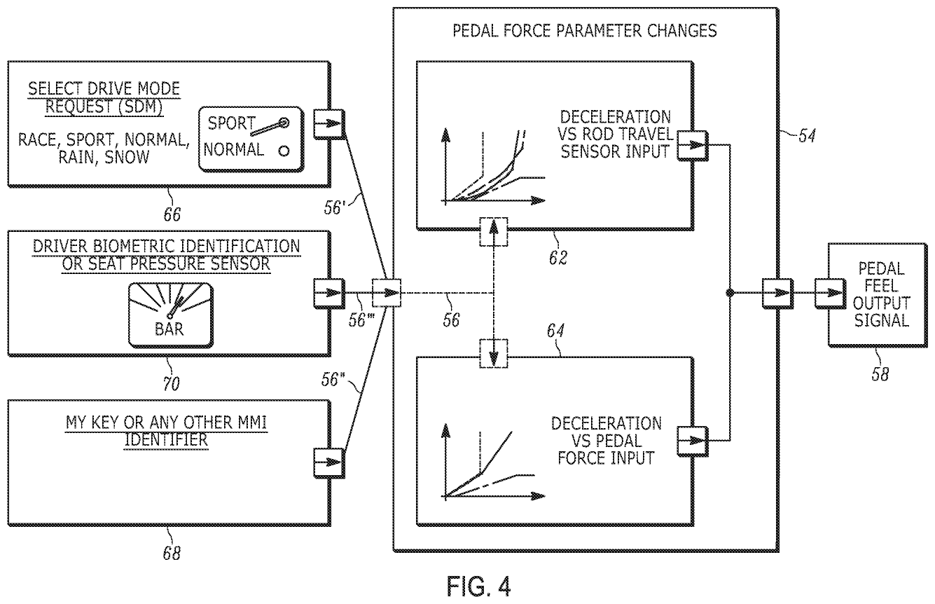

With reference to FIG. 4, the desired brake pedal feedback (via the pedal feel output signal 58) can be initiated and modified based on the input signal 56′ relating to the vehicle mode selection or the select drive mode (SDM) request of the driver such as comfort, sport normal, etc. Alternatively, the desired brake pedal feedback can be initiated or modified based on the input signal 56″ relating to any Man-Machine Interface (MMI) 68 available to the driver. For example, the MMI 68 can be a vehicle radio/instrument panel and the OEM can provide inputs in this radio/instrument panel to allow the driver to choose one of a plurality of desired pedal feedback options. This driver selected option can then be saved in the memory circuit 50. Still further, the desired brake pedal feedback can be initiated or modified based on the input signal 56′″ relating to driver biometric identification information 70, as obtained by, for example, a seat pressure sensor or an internal camera.

Thus the brake system 1 of the embodiment enables the driver to select a desired brake pedal feedback so as to adapt the pedal tuning with vehicle utilization and, in some cases, to provide a special setup depending on biometric or disability data of the driver.

FIG. 5 is a flow chart describing the steps of a method of the embodiment. In step 72, the input signal 56 is provided as noted above (e.g., from biometrics of the driver). In step 74, the processor circuit 54 determines a brake pedal feel based on the deceleration vs. pedal travel data of FIG. 2 and from the deceleration vs. pedal force FIG. 3. In step 76, a pedal feel output signal 58 is generated and, in step 78, based on the pedal feel output signal 58 initiated by the driver input signal 56, the ECU controls the output of the simulation device 4 to establish the desired and selected pedal feedback of the brake pedal 3.

The operations and algorithms described herein can be implemented as executable code within the micro-controller or control unit 12 having processor circuit 54 as described, or stored on a standalone computer or machine readable non-transitory tangible storage medium that are completed based on execution of the code by a processor circuit implemented using one or more integrated circuits. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a micro-processor circuit (not shown) and implemented using one or more integrated circuits, where execution of executable code stored in an internal memory circuit causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit 50 can be implemented, for example, using a non-volatile memory such as a programmable read only memory (PROM) or an EPROM, and/or a volatile memory such as a DRAM, etc.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A brake-by-wire vehicle brake system which is configured to operate in a hydraulic mode of operation and in a brake-by-wire mode of operation, the brake system comprising:
a brake pedal,
a pressure medium reservoir container constructed and arranged contain a pressure medium therein,
a hydraulic activation unit constructed and arranged to be activated by the brake pedal in the hydraulic mode of operation to control delivery of the pressure medium to wheel brakes of a vehicle,
a simulation device constructed and arranged to interact with the hydraulic activation unit such that in the brake-by-wire mode of operation, the brake pedal is disconnected from the hydraulic activation unit, with the simulation device providing brake pedal feedback to the driver,
an electrically controllable pressure supply device constructed and arranged to deliver the pressure medium to the wheel brakes during the brake-by-wire mode of operation, and
a control unit constructed and arranged to establish, at the simulation device, a desired brake pedal feedback based on driver input.

2. The system of claim 1, wherein the control unit includes a processor circuit constructed and arranged to generate a brake pedal feel output signal based on data regarding vehicle deceleration vs. travel of the brake pedal and on data regarding the vehicle deceleration vs. force on the brake pedal, and based on the brake pedal feel output signal, the control unit is constructed and arranged to control an output of the simulation device to establish the desired brake pedal feedback.

3. The system of claim 2, wherein the processor circuit is constructed and arranged to receive an input signal to initiate the desired brake pedal feedback, the input signal relating to a vehicle mode selection or a select drive mode (SDM) request of the driver.

4. The system of claim 2, wherein the processor circuit is constructed and arranged to receive an input signal to initiate the desired brake pedal feedback, the input signal relating to a Man-Machine Interface (MMI) available to the driver.

5. The system of claim 4, in combination with the MMI in the form of a vehicle instrument panel, the instrument panel including inputs to allow the driver to choose one of a plurality of desired brake pedal feedback options.

6. The system of claim 5, wherein the chosen, desired brake pedal feedback option is stored in a memory circuit of the control unit.

7. The system of claim 2, wherein the processor circuit is constructed and arranged to receive an input signal to initiate the desired brake pedal feedback, the input signal relating to driver biometric identification information.

8. The system of claim 7, further comprising a camera constructed and arranged to obtain the driver biometric identification information.

9. The system of claim 7, further comprising a vehicle seat pressure sensor constructed and arranged to obtain the driver biometric identification information.

10. A method of adjusting a brake pedal feedback in a brake-by-wire vehicle brake system which is configured to operate in a hydraulic mode of operation and in a brake-by-wire mode of operation, the brake system including a brake pedal and a simulation device associated with the brake pedal such that in a brake-by-wire mode of operation, the simulation device provides brake pedal feedback to the driver, the method comprising the steps of:
providing an input signal to a processor circuit of a control unit of the brake system, the input signal relating to a desired brake pedal feedback associated with a driver of the vehicle,
generating, by the processor circuit, a brake pedal feel output signal based on data regarding vehicle deceleration vs. travel of the brake pedal and on data regarding the vehicle deceleration vs. force on the brake pedal, and
based on the brake pedal feel output signal, controlling, via the control unit, an output of the simulation device to establish the desired brake pedal feedback.

11. The method of claim 10, wherein the input signal is provided by the driver by selecting a vehicle mode or by initiating a selecting mode (SDM) request.

12. The method of claim 10, wherein the input signal is provided through a Man-Machine Interface (MMI) available to the driver.

13. The method of claim 12, wherein the MMI is in the form of a vehicle instrument panel, the step of providing and input signal including selecting, by the driver, an input on the instrument panel relating to one of a plurality of desired brake pedal feedback options.

14. The method of claim 13, further comprising storing, in a memory circuit of the control unit, the selected, desired brake pedal feedback option.

15. The method of claim 10, wherein the input signal is provided based on driver biometric identification information.

16. The method of claim 15, further comprising using a camera to obtain the driver biometric identification information.

18. The method of claim 15, further comprising using a vehicle seat pressure sensor to obtain the driver biometric identification information.
